(19) United States
(12) Patent Application Publication
(10) Pub. No.: US 2026/0116541 A1
(43) Pub. Date: Apr. 30, 2026

(54) LOCKING DEVICE FOR A TRAY AND AN ADDITIONAL SUPPORT

(71) Applicant: Safran Seats, Plaisir (FR)

(72) Inventors: Hery Andriamanefo, Moissy-Cramayel (FR); Mélanie Philippon, Moissy-Cramayel (FR); Guillaume Dupuy, Moissy-Cramayel (FR)

(21) Appl. No.: 19/165,960

(22) PCT Filed: Mar. 4, 2024
(86) PCT No.: PCT/EP2024/055570

§ 371 Date: Sep. 16, 2025

(30) Foreign Application Priority Data
Apr. 14, 2023 (FR) FR2303740

(51) Int. Cl. B64D 11/06; B64D 11/00

(52) U.S. Cl. CPC B64D 11/0638; B64D 11/00152; B64D 11/0636

(57) ABSTRACT

The invention relates to a seat comprising:

a backrest,

a tray mounted on the backrest,

an additional support mounted on the tray, and

a locking device capable of selectively assuming:

a locked state, in which the locking device covers an upper edge of the tray and an upper edge of the additional support in order to hold the tray,

a partially unlocked state, in which the locking device covers the upper edge of the tray and is disengaged from the upper edge of the additional support, and

a completely unlocked state, in which the locking device is disengaged from the upper edge of the additional support and from the upper edge of the tray.

The present invention relates to a locking device for a tray table and an additional support, in particular mounted on a seat. The invention finds a particularly advantageous, but not exclusive, application with airplane seats, in particular economy class airplane seats.

An economy class airplane seat comprises in a manner known per se at least one seating basis, at least one backrest and on retractable tray table arranged on a rear face of the backrest.

An economy class airline seat is generally not equipped with a multimedia system, also designated by the acronym “IFE” for “In-Flight Entertainment”. Consequently, to enjoy video and/or music content, a passenger must use an additional portable electronic device, in particular a multimedia electronic device such as for example a mobile phone or a digital tray table belonging to the passenger.

For this purpose, a device for holding a portable electronic device comprising a portable electronic device support is positioned on the rear face of the backrest and movable between a folded position and a deployed position in which it is capable of supporting the portable electronic device. Such a holding device is described in document WO2016/165982.

When such a portable electronic device support is located at mid-height of a seat tray table, it is necessary to provide two locking devices, namely a first locking device for the tray table and a second locking device for the portable electronic device support, SO that both can be held independently in a storage position.

The presence of these locking devices poses some problems for meeting a head impact criterion, also known as the acronym “HIC” for “Head Injury Criterion”. The criterion “HIC” depends on maximum values of decelerations experienced by the passenger's head during a crash test as well as time limits of a deceleration curve calculated during the test.

However, the greater the number of obstacles, such as a seat tray table and/or a portable electronic device support, is in the trajectory of a passenger's head, the more the associated shocks are likely to increase the criterion “HIC” beyond limit thresholds acceptable by aeronautical standards.

The objective of the invention is to effectively remedy this drawback by offering a seat comprising:

a backrest,

a tray table mounted on the backrest and movable between a stored position in which the tray table is pressed against the backrest, in particular against a rear face of the backrest,

and a deployed position, in which the tray table is spaced away from the backrest,

an additional support, in particular configured to support a portable electronic device, mounted on the tray table, in particular on a rear face of the tray table, and movable between a stored position, in which the additional support is pressed against the tray table, in particular against the rear face of the tray table, and a deployed position, in which the additional support is spaced away from the tray table, in particular from the rear face of the tray table, and

a locking device capable of selectively taking:

a locked state, in which the locking device covers an upper edge of the tray table and an upper edge of the additional support, to hold the tray table and the additional support in the stored position,

a partially unlocked state, in which the locking device covers the upper edge of the tray table and is disengaged from the upper edge of the additional support, to allow the additional support to move into the deployed position while holding the tray table in the stored position, and

a fully unlocked state, in which the locking device is disengaged from the upper edge of the additional support and the upper edge of the tray table, to allow the tray table to move into the deployed position.

The invention thus makes it possible, thanks to the locking device common to the tray table and the additional support, to eliminate an additional lock likely to collide with a passenger's head. With such as configuration, the invention therefore makes it easier to comply with the “HIC” criterion.

Furthermore, the invention allows to simplify the integration of the tray table and the additional support in the rear of the seat backrest.

According to a first embodiment of the invention, the locking device comprises a single part movable in rotation and/or in translation relative to the backrest.

The locking device is then configured such that:

in the locked state, in which the single part is in particular in a first angular position, the single part covers an upper edge of the tray table and an upper edge of the additional support,

in the partially unlocked state, in which the single part is in particular in a second angular position, the single part covers the upper edge of the tray table and is disengaged from the upper edge of the additional support, and

in the fully unlocked state, in which the single part is in particular in a third angular position, the single part is disengaged from the upper edge of the tray table and the upper edge of the additional support.

According to a second embodiment of the invention, the locking device comprises a first part movable relative to the backrest and a second part movable relative to the first part.

In particular, the first part is capable of moving in rotation and/or in translation relative to the backrest.

Furthermore, the second part is capable of moving in rotation and/or in translation relative to the first part.

The locking device is then configured such that:

in the locked state the first part covers an upper edge of the tray table and the second part covers an upper edge of the additional support,

in the partially unlocked state the first part covers the upper edge of the tray table and the second part is disengaged from the upper edge of the additional support, and

in the fully unlocked state the first part is disengaged from the upper edge of the tray table and the second part is disengaged from the upper edge of the additional support.

According to one embodiment of the invention, the tray table comprises a removable fixing device for the additional support.

According to one embodiment of the invention, the seat is an airplane seat.

The invention also relates to an airplane comprising a seat such as previously defined.

The invention will be better understood and other characteristics and advantages will appear by reading the following detailed description, which includes embodiments given for illustrative purposes with reference to the accompanying Figures, presented as way of non-limiting examples, which may serve to complete the understanding of the present invention and the description of its implementation and eventually contribute to its definition, wherein:

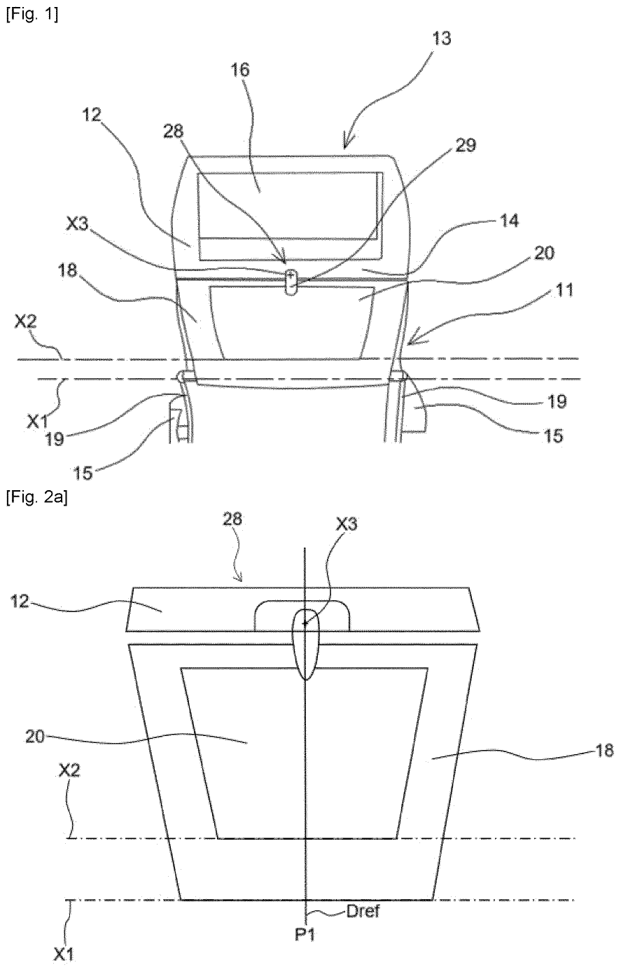

FIG. 1 is a rear view of a seat comprising a locking device for a tray table and an additional support according to the invention;

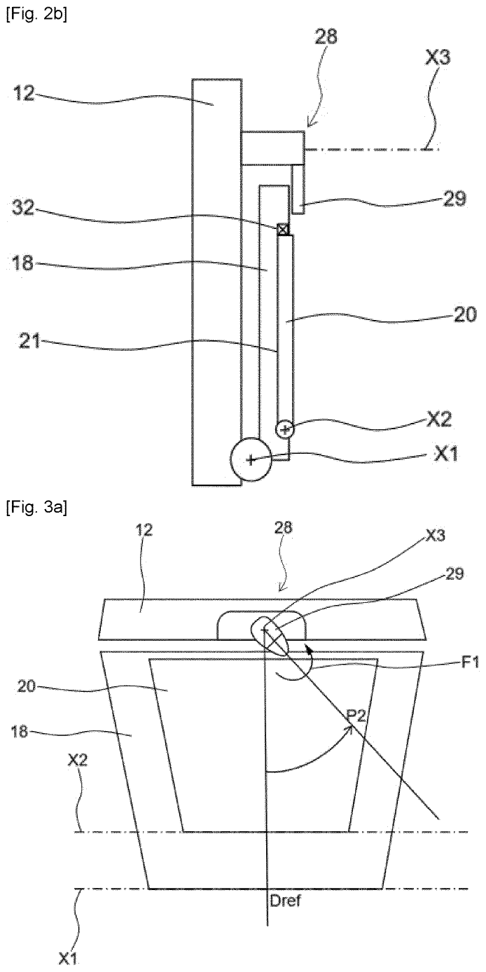

FIGS. 2a and 2b are respectively front and side views of the locking device according to the invention in a locked state;

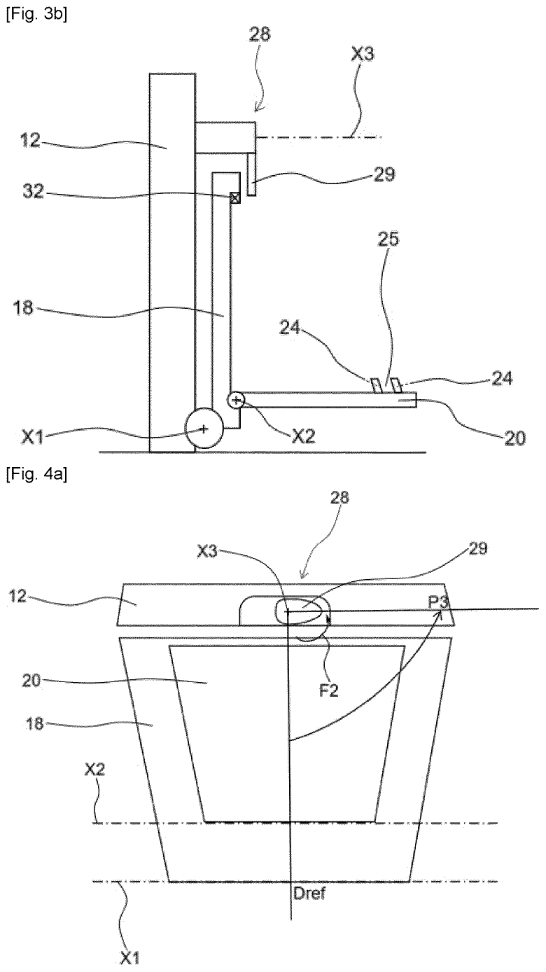

FIGS. 3a and 3b are respectively front and side views of the locking device according to the invention in a partially unlocked state;

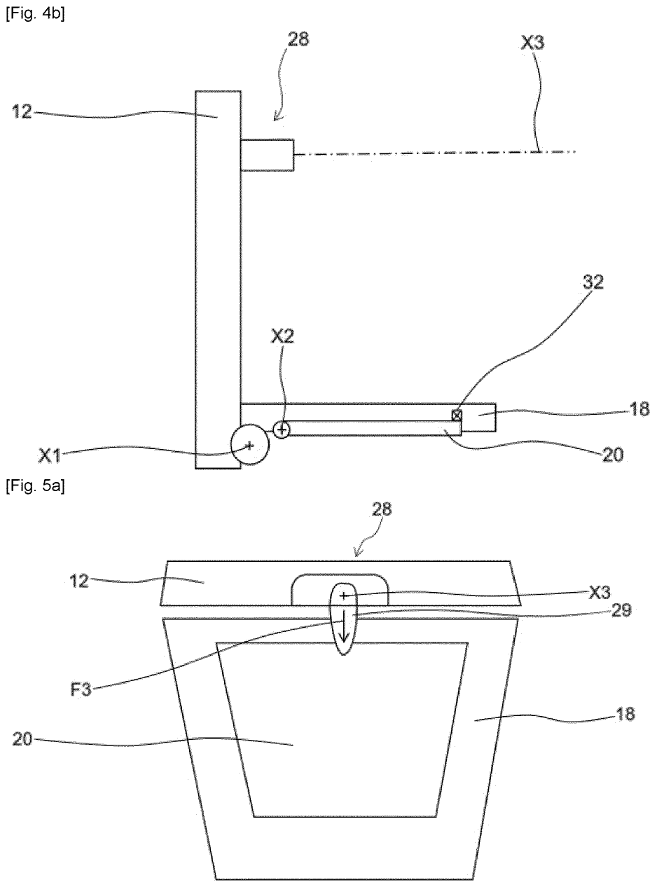

FIGS. 4a and 4b are respectively front and side views of the locking device according to the invention in a fully unlocked state;

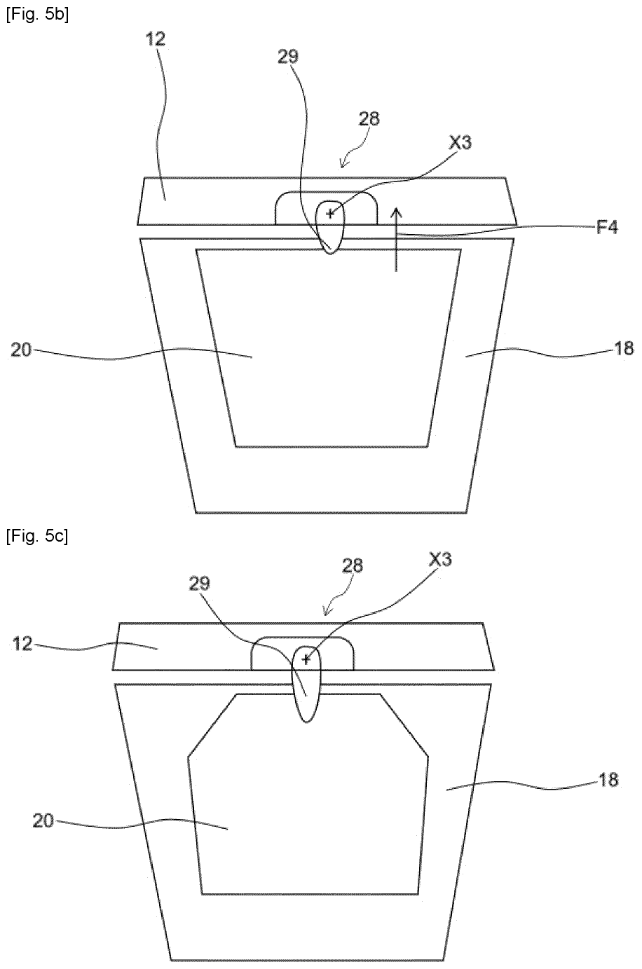

FIGS. 5a, 5b and 5c illustrate different possible configurations of the locking device and the additional support according to the invention;

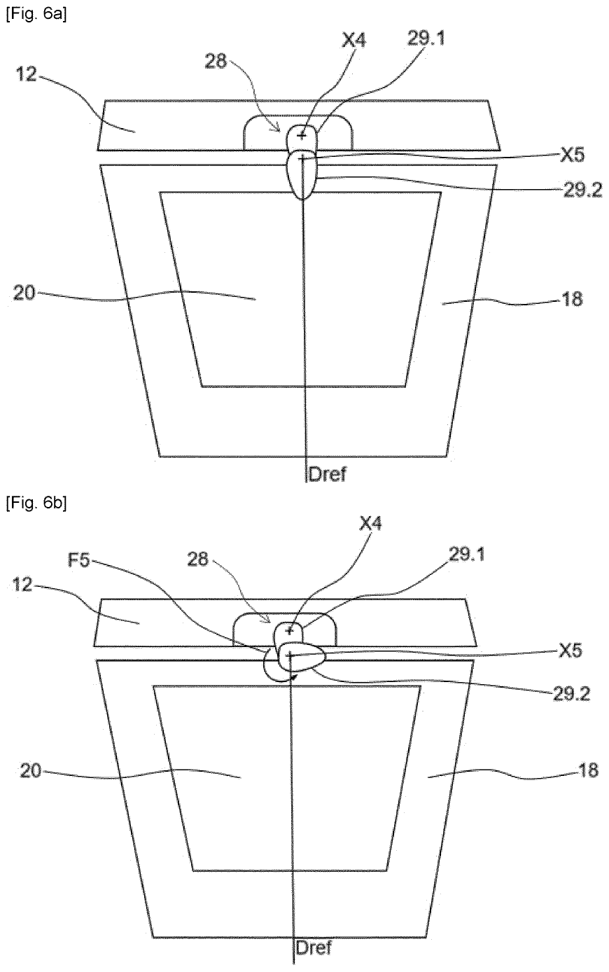

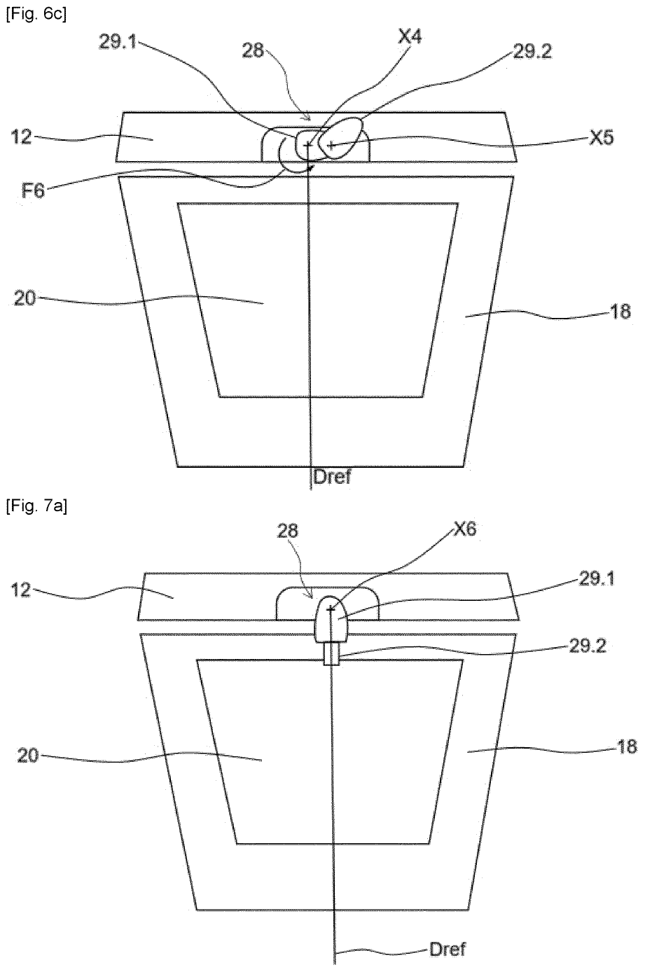

FIGS. 6a, 6b and 6c illustrate a first alternative embodiment of the locking device according to the invention respectively in a locked, partially unlocked and fully unlocked state; and

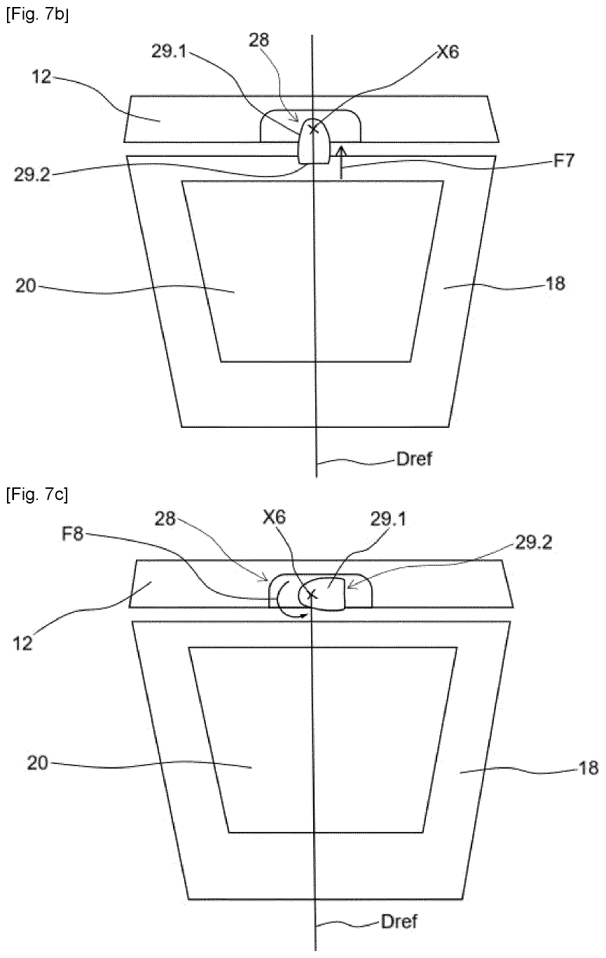

FIGS. 7a, 7b and 7c illustrate a second alternative embodiment of the locking device according to the invention respectively in a locked, partially unlocked and fully unlocked state.

It should be noted that the common structural and/or functional elements in the different embodiments have the same references. Thus, unless otherwise stated, such elements have identical structural, dimensional and material properties.

In the remainder of the description, the relative terms such as “before”, “rear”, “horizontal”, “vertical” are understood by reference to the common meaning that a passenger in the seat according to the invention in the position of use would give them.

FIG. 1 is a rear view of a seat 10, in particular to be installed in an airplane. The seat 10 comprises a seating basis 11 and a backrest 12. The backrest 12 comprises a front face 13 for a passenger to rest therein, and a rear face 14 opposite the front face 13. The rear face 14 of the backrest 12 is turned towards a passenger behind the seat 10.

The backrest 12 can be articulated relative to the seating basis 11 to take tilted positions.

A storage compartment 16 can be arranged in the upper part of the backrest 12 and armrests 15 may be located on either side of the seat 10.

A tray table 18, also called a meal tray table 18, is positioned on the side of the rear face 14 of the backrest 12. The tray table 18 is mounted on the backrest 12. The tray table 18 is movable relative to the backrest 12 between a stored position, in which the tray table 18 is pressed against the rear face 14 of the backrest 12, and a deployed position, in which the tray table 18 is spaced apart from the backrest 12.

For this purpose, the tray table 18 is mounted on the rear face 14 of the backrest 12 by means of at least one pivot connection, defining a horizontal axis of rotation X1. The pivot connection can be defined by arms 19 fixed to a structure of the seat 10.

In the deployed position, the tray table 18 advantageously extends horizontally, to support objects placed by the passenger, in particular a meal tray and/or personal objects.

The tray table 18 may comprise a plate with a rectangular, square, trapezoidal or any other shape suitable for the application.

An additional support 20 is configured to support in particular a portable electronic device, such as a mobile phone, digital tablet, DVD player, laptop computer or any other electronic device the passenger wishes to have available on board.

The additional support 20 is mounted on a rear face 21 of the tray table 18. The additional support 20 is movable between a stored position, in which the additional support 20 is pressed against a rear face 21 of the tray table 18, when the tray table 18 is in the stored position, and a deployed position, in which the additional support 20 is spaced apart from the rear face 21 of the tray table 18.

For this purpose, the additional support 20 is mounted on the rear face 21 of the tray table 18 via at least one pivot connection, defining a horizontal axis of rotation X2.

The horizontal axis of rotation X2 of the additional support 20 is advantageously parallel to the horizontal axis of rotation X1 of the tray table 18.

In the deployed position, the additional support 20 extends along a substantially horizontal plane to support the portable electronic device.

The additional support 20 may comprise a plate with a rectangular, square, trapezoidal or any other shape suitable for the application.

Furthermore, a locking device 28 is capable of taking selectively:

a locked state, in which the locking device 28 covers an upper edge of the tray table 18 and an upper edge of the additional support 20, to maintain the tray table 18 and the additional support 20 in the stored position,

a partially unlocked state, in which the locking device 28 covers the upper edge of the tray table 18 and is disengaged from the upper edge of the additional support 20, to allow the additional support 20 to move into the deployed position while maintaining the tray table 18 in the stored position, and

a fully unlocked state, in which the locking device 28 is disengaged from the upper edge of the additional support 20 and the upper edge of the tray table 18 to allow the tray table 18 to move into the deployed position.

FIGS. 2a, 2b, 3a, 3b, and 4a, 4b are front and side views of the locking device according to the invention respectively in a locked state, a partially unlocked state and a fully unlocked state.

In the embodiment in FIGS. 2a, 2b, 3a, 3b, and 4a, 4b, the locking device 28 comprises a single part 29 movable relative to the backrest 12 of the seat 10.

According to the exemplary embodiment in FIGS. 2a, 2b, 3a, 3b, and 4a, 4b, the single part 29 is movable in rotation relative to the backrest 12 by means of at least one pivot connection defining an axis of rotation X3.

The pivot connection with the axis of rotation X3 is interposed between the single part 29 and the backrest 12 of the seat 10. Advantageously, the axis of rotation X3 is perpendicular to the backrest 12.

Alternatively or additionally, the single part 29 is movable in translation relative to the backrest 12 along an axis of translation substantially parallel perpendicular to the backrest 12.

As illustrated in FIGS. 2a and 2b, in a first position P1, corresponding to the locked state, the single part 29 covers an upper edge of the tray table 18 and an upper edge of the additional support 20. In the first position P1, the locking device 28 ensures that the tray table 18 and the additional support 20 are held in the stored position.

The first position P1 is for example of the order of zero degrees relative to a direction of reference Dref.

The direction of reference Dref may be in particular a vertical axis, likely to substantially or completely correspond to a longitudinal axis of extension of the backrest 12 of the seat 10.

As illustrated in FIGS. 3a and 3b, in a second position P2, corresponding to the partially unlocked state, the single part 29 covers the upper edge of the tray table 18 and is disengage from the upper edge of the additional support 20. In the second position P2, the locking device 28 enable to disengage the additional support 20 in the deployed position and hold the tray table 18 in the stored position.

The second position P2 is comprised for example between 30 and 60 degrees, notably of the order of 45 degrees, relative to the direction of reference Dref.

The transition from the first position P1 to the second position P2 is carried out by rotation of the single part 29 around the axis of rotation X3, represented by an arrow F1 in FIG. 3a.

As can be seen in FIG. 3b, the additional support 20 can include retaining means for the portable electronic device, such as at least one projection 24 and/or at least one groove 25, against which a lower edge of the portable electronic device can bear.

As illustrated in FIGS. 4a and 4b, in a third position P3, corresponding to the fully unlocked state, the single part 29 is disengaged from the upper edge of the tray table 18 and the upper edge of the additional support 20. In the third position P3, the locking device 28 enables to disengage the tray table 18 in the deployed position.

The third position P3 is comprised for example between 60 and 180 degrees, notably of the order of 90 degrees, relative to the direction of reference Dref.

The transition from the second position P2 to the third position P3 is carried out by rotation of the single part 29 around the axis of rotation X3, represented by an arrow F2 in FIG. 4a.

In order to hold the additional support 20 against the rear face 21 of the tray table 18, when the tray table 18 is in the deployed position, and thus prevent the additional support 20 from falling onto the passenger's knees, the tray table 18 may comprise a removable fixing device 32 for the additional support 20 on the tray table 18, as shown in FIGS. 2b, 3b and 4b.

The removable fixing device 32 can be chosen in particular among magnets, snap fasteners, a hook-and-loop fastening system, a textile hook-and-loop fastening system, a latching device or any other device making it possible to ensure a connection between the additional support 20 and the tray table 18, when the tray table 18 is in the deployed position, while making it possible to easily disengage the additional support 20 from the tray table 18 in order to move it into the deployed position when the locking device 28 is in a partially unlocked state.

The single part 29 can comprise a conventional lock for locking the tray table 18 in the stored position.

FIGS. 5a, 5b and 5c illustrate different possible configurations of the locking device 28 and additional support 20 according to the invention.

As illustrated in FIG. 5a, the locking device 28, comprising the single part 29, can be elongated, according to a longitudinal direction of extension of the locking device 28 represented by an arrow F3 in FIG. 5a, relative to a standard lock so as to cover the upper edge of the tray table 18 and the upper edge of the additional support 20, when the locking device 28 is in a locked state.

Thus, compared to a standard lock which has a length of the order of 4 cm, the locking device 28 according to the invention has a length between 5 cm and 8 cm, in particular between 5 cm and 6 cm.

Alternatively or additionally, the upper edge of the additional support 20 can be arranged near the upper edge of the tray table 18. In the locked state, the locking device 28 can then cover the upper edges of the tray table 18 and the additional support 20. In such a configuration, the locking device 28 according to the invention can have a standard length of the order of 4 cm.

According to the embodiment in FIG. 5b, the additional support 20 can be extended upwards, according to a direction of extension of the additional support 20 represented by an arrow F4, in order to cooperate with the single part 29, in the locked state.

According to the embodiment in FIG. 5c, the additional support 20 is elongated locally, in a vertical direction of extension of the additional support 20 (when the tray table 18 and the additional support 20 are in a stored state), in particular in a central part of the additional support 20, in order to cooperate with the single part 29, in the locked state.

FIGS. 6a, 6b and 6c illustrate a first alternative embodiment of the locking device 28 according to the invention respectively in a locked, partially unlocked and fully unlocked state.

In the embodiment in FIGS. 6a, 6b, and 6c, the device of locking 28 comprises at least a first part 29.1 movable relative to the backrest 12 and at least a second part 29.2 movable relative to the first part 29.1.

In particular, the first part 29.1 can move in rotation relative to the backrest 12 and/or the second part 29.2 can move in rotation relative to the first part 29.1.

For this purpose, the locking device 28 comprises a first connection, in particular a first pivot connection, between the first part 29.1 and the backrest 12 and a second connection, in particular a second pivot connection, between the second part 29.2 and the first part 29.1.

The first pivot connection defines an axis of rotation X4 and the second pivot connection defines an axis of rotation X5.

The axis of rotation X4 between the first part 29.1 and the backrest 12 and the axis of rotation X5 between the second part 29.2 and the first part 29.1 can advantageously be substantially perpendicular to the backrest 12.

In addition, the axis of rotation X4 between the first part 29.1 and the backrest 12 and the axis of rotation X5 between the second part 29.2 and the first part 29.1 may be parallel to each other. The axes of rotation X4 and X5 are distinct from each other.

As illustrated in FIG. 6a, in the locked state, the first part 29.1 covers the upper edge of the tray table 18 and the second part 29.2 covers the upper edge of the additional support 20.

The first part 29.1 is then aligned with the second part 29.2. The parts 29.1, 29.2 are also aligned with the direction of reference Dref.

As illustrated in FIG. 6b, in the partially unlocked state, the first part 29.1 covers the upper edge of the tray table 18 and the second part 29.2 is disengaged from the upper edge of the additional support 20.

For this purpose, the second part 29.2 is moved relative to the first part 29.1, in particular in rotation in a direction represented by an arrow F5 according to the embodiment in FIGS. 6a, 6b, and 6c, around the axis of rotation X5, so as to disengage the upper edge of the additional support 20.

The second part 29.2 of the locking device 28 then forms a non-zero angle with the direction of reference Dref, while the first part 29.1 of the locking device 28 remains aligned with the direction of reference Dref.

As illustrated in FIG. 6c, in the fully unlocked state, the first part 29.1 is disengaged from the upper edge of the tray table 18 and the second part 29.2 is disengaged from the upper edge of the additional support 20.

For this purpose, the first part 29.1 is moved relative to the backrest 12, in particular in rotation in a direction represented by an arrow F6 according to the embodiment in FIGS. 6a, 6b, and 6c, around the axis of rotation X4, so as to disengage the upper edge of the tray table 18.

In particular, the first part 29.1 is moved relative to the backrest 12 by rotation relative to the direction of reference Dref with an angle for example between 60 and 180 degrees, in particular of the order of 90 degrees.

The first part 29.1 and the second part 29.2 of the locking device 28 then form a non-zero angle with the direction

FIGS. 7a, 7b and 7c illustrate a second alternative embodiment, of the locking device 28 according to the invention respectively in a locked, partially unlocked and fully unlocked state.

In the embodiment in FIGS. 7a, 7b, and 7c, the locking device 28 comprises at least a first part 29.1 movable relative to the backrest 12 and at least a second part 29.2 movable relative to the first part 29.1.

In particular, the first part 29.1 can move in rotation relative to the backrest 12 and/or the second part 29.2 can move in translation relative to the first part 29.1.

For this purpose, the locking device 28 comprises a first connection, in particular a pivot connection having an axis of rotation X6, between the first part 29.1 and the backrest 12. The locking device 28 comprises a second connection, in particular a sliding connection having an axis of translation extending in a direction of extension of the first part 29.1, between the second part 29.2 and the first part 29.1, between an extended position and a retracted position.

As illustrated in FIG. 7a, in the locked state, the first part 29.1 covers the upper edge of the tray table 18 and the second part 29.2, in the extended position, covers the upper edge of the additional support 20.

The first part 29.1 and the second part 29.2 are then aligned with the direction of reference Dref.

As illustrated in FIG. 7b, in the partially unlocked state, the first part 29.1 covers the upper edge of the tray table 18 and the second part 29.2, in the retracted position, is disengaged from the upper edge of the additional support 20.

For this purpose, the second part 29.2, having in particular the form of a tongue, is moved relative to the first part 29.1, in particular in translation in a direction represented by an arrow F7, according to the embodiment in FIGS. 7a, 7b, and 7c.

In the partially unlocked state, the first part 29.1 remains aligned with the direction of reference Dref.

As illustrated in FIG. 7c, in the fully unlocked state, the first part 29.1 is disengaged from the upper edge of the tray table 18 and the second part 29.2 is disengaged from the upper edge of the additional support 20.

For this purpose, the first part 29.1 is moved relative to the backrest 12, in particular in rotation in a direction represented by an arrow F8 according to the embodiment in FIGS. 7a, 7b, and 7c, around the axis of rotation X6, so as to disengage the upper edge of the tray table 18.

In particular, the first part 29.1 is moved relative to the backrest 12 by rotation relative to the direction of reference Dref with an angle for example between 60 and 180 degrees, in particular of the order of 90 degrees.

According to an alternative embodiment not shown, the first part 29.1 can move in translation relative to the backrest 12 and/or the second part 29.2 can move in rotation relative to the first part 29.1.

Finally, according to another alternative embodiment not shown, the first part 29.1 can move in translation relative to the backrest 12 and/or the second part 29.2 can move in translation relative to the first part 29.1.

The invention further relates to an airplane comprising a seat 10 equipped with a tray table 18, an additional support 20, and a locking device 28 as previously described.

Of course, the different characteristics, variants and/or embodiments of the present invention may be associated with each other in various combinations insofar as they are not incompatible with or exclusive of one another.

Furthermore, the invention is not limited to the embodiments described above and provided solely by way of example. It encompasses various modifications, alternative forms and other variants which person skilled in the art may envisage in the context of the present invention and in particular any combination of the various operating modes described above may be taken separately or in combination.

1. A seat comprising:
a backrest;
a tray table mounted on the backrest and movable between a stored position, in which the tray table is pressed against the backrest, and a deployed position, in which the tray table is spaced apart from the backrest; and
an additional support mounted on the tray table and movable between a stored position, in which the additional support is pressed against the tray table, and a deployed position, in which the additional support is spaced apart from the tray table, and a locking device capable of selectively taking:
a locked state, in which the locking device covers an upper edge of the tray table and an upper edge of the additional support, to maintain the tray table and the additional support in the stored position;
a partially unlocked state, in which the locking device covers the upper edge of the tray table and is disengaged from the upper edge of the additional support, to allow the additional support to move into the deployed position while maintaining the tray table in the stored position; and
a fully unlocked state, in which the locking device is disengaged from the upper edge of the additional support and the upper edge of the tray table, to allow the tray table to move into the deployed position.

2. The seat according to claim 1, wherein the locking device comprises a single part movable in rotation and/or in translation relative to the backrest.

3. The seat according to claim 2, wherein the locking device is configured in such a way that:
in the locked state, in which the single part covers an upper edge of the tray table and an upper edge of the additional support, in the partially unlocked state, the single part covers the upper edge of the tray table and is disengaged from the upper edge of the additional support; and
in the fully unlocked state, the single part is disengaged from the upper edge of the tray table and the upper edge of the additional support.

4. The seat according to claim 1, wherein the locking device comprises a first part movable relative to the backrest and a second part movable relative to the first part.

5. The seat according to claim 4, wherein the first part is movable in rotation and/or in translation relative to the backrest.

6. The seat according to claim 4, wherein the second part is movable in rotation and/or in translation relative to the first part.

7. The seat according to claim 4, wherein the locking device is configured in such a way that:
in the locked state the first part covers an upper edge of the tray table and the second part covers an upper edge of the additional support; and
in the partially unlocked state the first part covers the upper edge of the tray table and the second part is disengaged from the upper edge of the additional support, and
in the fully unlocked state, the first part is disengaged from the upper edge of the tray table and the second part is disengaged from the upper edge of the additional support.

8. The seat according to claim 1, wherein the tray table comprises a removable fixing device with the additional support.

9. The seat according to claim 1, wherein the seat is an airplane seat.

10. An aircraft comprising a seat according to claim 1.
